(19) United States
(12) Patent Application Publication
(10) Pub. No.: US 2008/0267414 A1
(43) Pub. Date: Oct. 30, 2008

(54) VOICE OUTPUTTING APPARATUS AND VOICE OUTPUTTING METHOD

(75) Inventor: Takanobu Mukaide, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/928,301

(22) Filed: Oct. 30, 2007

(30) Foreign Application Priority Data
Apr. 27, 2007 (JP) 2007-120105

(51) Int. Cl. H04R 5/00

(52) U.S. Cl. 381/23

(57) ABSTRACT

According to one embodiment, an audio outputting apparatus comprises: an audio outputting apparatus comprising: a first input unit to which a first compressed audio stream is input with respect to each frame, the first compressed audio stream including a compressed audio data and an extended data; a second input unit to which a second compressed audio stream is input with respect to each frame, the second compressed audio stream including a compressed audio data; a multiplex unit that inserts the second compressed audio stream into an extended data region of a corresponding frame of the first compressed audio stream to generate a multiplexed compressed audio stream; and an output unit that externally outputs the multiplexed compressed audio stream in a predetermined transmission mode.

### CROSS-REFERENCE TO RELATED APPLICATIONS

This application is based upon and claims the benefit of priority from Japanese Patent Application No. 2007-120105, filed Apr. 27, 2007, the entire contents of which are incorporated herein by reference.

### BACKGROUND

1. Field

One embodiment of the invention relates to an improvement in a voice outputting apparatus and a voice outputting method for outputting a compressed voice stream.

2. Description of the Related Art

As is well known, in recent years, an optical disk of DVD (digital versatile disk) or the like as a digital record medium has been spread. Further, currently, there is also completed a next generation DVD standard in correspondence with high vision referred to as so-to-speak HD (high definition)-DVD capable of carrying out recording of a density higher than that of DVD.

According to an optical disk of this kind, a data of an image, a voice or the like is compressed to be recorded. Therefore, according to an optical disk reproducing apparatus for reproducing the optical disk, an image display or a voice reproduction can be carried out by a monitor or a speaker which is attached externally by decoding a stream of a compressed image, a compressed voice or the like read from the optical disk to be converted into analog to be outputted.

On the other hand, according to such an optical disk reproducing apparatus, it is conceived to enable to output a compressed voice stream before being decoded to outside. Thereby, a voice reproduction having high sound quality can be carried out in multichannels by externally attaching an AV amplifier or the like having a function of decoding the compressed voice stream.

Meanwhile, the next generation DVD standard rectifies to deal with various kinds of voice data constituting, for example, sub audio, effect audio or the like other than a voice data constituting main audio. Therefore, efficient formation in outputting a plurality of kinds of compressed voice streams to outside is requested for the optical disk reproducing apparatus.

JP-A-2001-251266 discloses a constitution of inserting modified information to a vacant region of PCR (program clock reference) packet of MPEG (moving picture experts group) 2-TS (transport stream) for outputting a digital stream by a bit rate near to a previously determined transmission rate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block constitution diagram showing an embodiment of the invention and shown for explaining an outline of a disk reproducing apparatus.

FIG. 2 is an exemplary diagram shown for explaining structures of a compressed voice stream and a noncompressed voice data dealt with by the disk reproducing apparatus according to the embodiment.

FIG. 3 is an exemplary diagram shown for explaining a multiplex processing operation at a multiplex processing portion of the disk reproducing apparatus according to the embodiment.

FIG. 4 is an exemplary flowchart shown for explaining a portion of the multiplex processing operation of the disk reproducing apparatus according to the embodiment.

FIG. 5 is an exemplary flowchart shown for explaining a remaining portion of the multiplex processing operation of the disk reproducing apparatus according to the embodiment.

FIG. 6 is an exemplary block constitution diagram shown for explaining an example of an AV amplifier according to the embodiment.

FIG. 7 is an exemplary flowchart shown for explaining a voice reproduction processing operation of the AV amplifier according to the embodiment.

### DETAILED DESCRIPTION

Various embodiments according to the invention will be described hereinafter with reference to the accompanying drawings. In general, according to one embodiment of the invention, a voice outputting apparatus comprising: a first input unit to which a first compressed voice stream is input with respect to each frame, the first compressed voice stream including a compressed voice data and an extended data; a second input unit to which a second compressed voice stream is input with respect to each frame, the second compressed voice stream including a compressed voice data; a multiplex unit that inserts the second compressed voice stream into an extended data region of a corresponding frame of the first compressed voice stream to generate a multiplexed compressed voice stream; and an output unit that externally outputs the multiplexed compressed voice stream in a predetermined transmission mode.

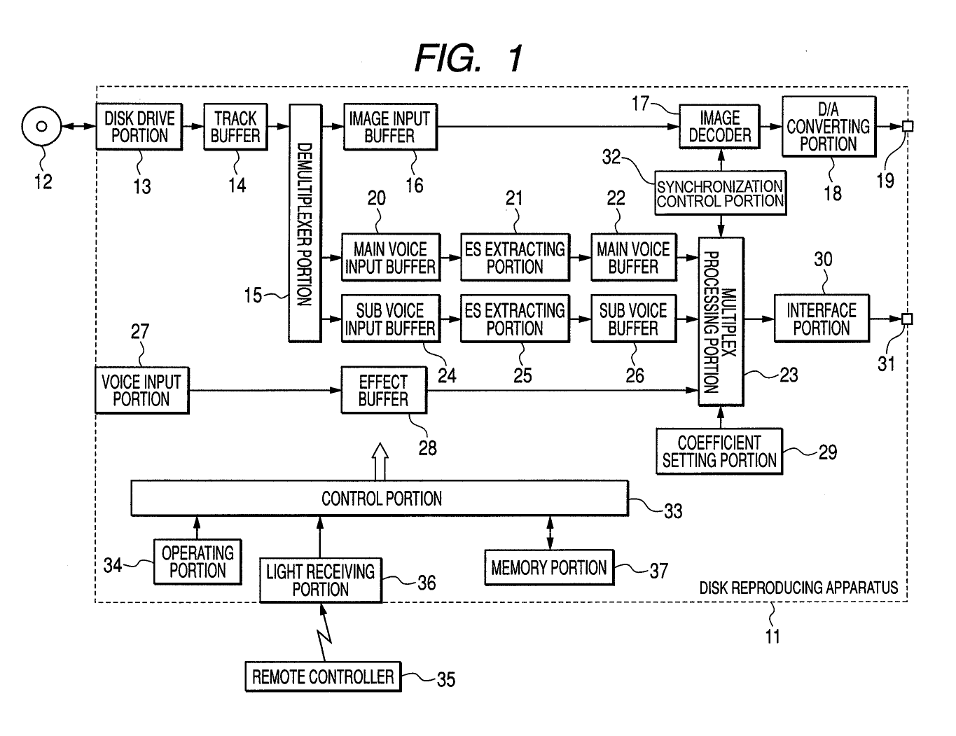

An embodiment of the invention will be explained in details in reference to the drawings as follows. FIG. 1 shows an outline of a disk reproducing apparatus 11 explained in the embodiment. The disk reproducing apparatus 11 is mounted with an optical disk 12 of, for example, HD-DVD or the like and is provided with a disk drive portion 13 for reading a record data thereof.

Further, when the data read from the optical disk 12 by the disk drive portion 13 is temporarily stored to a track buffer 14 and thereafter, supplied to a demultiplexer portion 15. The demultiplexer portion 15 separates the input data into a compressed image stream, and two compressed voice streams constituting main audio and sub audio.

The compressed image stream thereamong is constituted by a plurality of video packs (V_PCK). The compressed image stream is stored to an image input buffer 16 and thereafter, supplied to an image decoder 17 to be subjected to a decoding processing. Further, the decoded image data is supplied to a D/A (digital/analog) converting portion 18 to be converted into an analog image data, thereafter, outputted to outside by way of an image output terminal 19 to be subjected to an image display by, for example, a monitor, not illustrated.

Further, the first compressed voice stream constituting main audio separated by the demultiplexer portion 15 is constituted by a plurality of main audio packs (MA_PCK). The compressed voice stream is stored to a main voice input buffer 20, thereafter, supplied to an ES (elementary stream) extracting portion 21 to thereby extract main audio ES (MA_ES) by a unit of a frame. Further, the main audio ES (MA_ES) outputted from the ES extracting portion 21 is stored to a main voice buffer 22, thereafter, supplied to a multiplex processing portion 23.

Further, the second compressed voice stream constituting sub audio separated by the demultiplexer portion 15 is constituted by a plurality of sub audio packs (SA_PCK). The compressed voice stream is stored to a sub voice input buffer 24, thereafter, supplied to an ES extracting portion 25 to extract sub audio ES (SA_ES) by a unit of a frame. Further, sub audio ES (SA_ES) outputted from the ES extracting portion 25 is stored to a sub voice buffer 26, thereafter, supplied to the multiplex processing portion 23.

Further, the disk reproducing apparatus 11 includes a voice input portion 27. The voice input portion 27 acquires a noncompressed (PCM: pulse code modulation) voice data (EF_PCM) constituting effect audio from, for example, a removable information record medium, e network server or the like. The noncompressed voice data (EF_PCM) acquired by the voice input portion 27 is stored to an effect buffer 28, thereafter, supplied to the multiplex processing portion 23.

Further, the multiplex processing portion 23 is supplied with a mixing coefficient set to a coefficient setting portion 29. The mixing coefficient is acquired from the optical disk 12 in reproducing and the coefficient is utilized in mixing main audio, sub audio and effect audio in an AV amplifier mentioned later.

Further, the multiplex processing portion 23 generates a single piece of compressed voice stream by multiplexing main audio ES (MA_ES) stored to the main voice buffer 22, sub audio ES (SA_ES) stored to the sub voice buffer 26, the noncompressed voice data (EF_PCM) stored to the effect buffer 28, and the mixing coefficient supplied from the coefficient setting portion 29.

The compressed voice stream generated by the multiplex processing portion 23 is converted into a transmission mode in conformity with, for example, HDMI (high definition multimedia interface) standard or the like by an interface portion 30, thereafter, outputted to outside by way of a digital voice output terminal 31. The digital voice output terminal 31 is connected with, for example, an AV amplifier having a function of decoding, for example, the compressed voice stream to be able to carry out a voice reproduction having a high sound quality in multichannels.

Further, according to the image decoder 17 and the multiplex processing portion 23, an output timing of the compressed image stream and an output timing of the compressed voice stream are controlled by a synchronization control portion 32. Thereby, generally, the displayed image and the reproduced voice are controlled to synchronize with each other.

Here, according to the disk reproducing apparatus 11, all operations thereof including the above-described reproducing operation are comprehensively controlled by a control portion 33. The control portion 33 includes CPU (central processing unit) or the like, receives operation information from an operating portion 34, or operation information transmitted from a remote controller 35 and received by a light receiving portion 36 and respectively controls respective portion such that a content of operation is reflected.

In this case, the control portion 33 utilizes a memory portion 37. The memory portion 37 includes ROM (read only memory) stored with a control program executed by CPU of the control portion 33, RAM (random access memory) for providing an operation area to the CPU, and an involatile memory for storing various setting information and control information or the like.

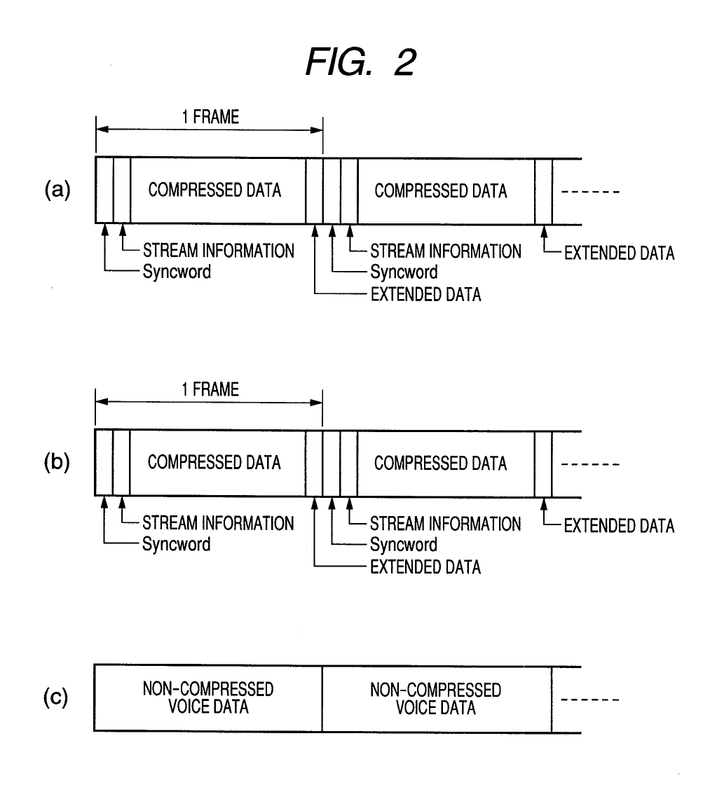

Here, a multiplex processing operation by the multiplex processing portion 23 will be explained. That is, according to main audio ES (MA_ES) constituting the compressed voice stream stored to the main voice buffer 22, as shown by FIG. 2 (a), 1 frame is constituted from stream information, compressed data and extended data constituting a head by Syncword constituting synchronization information.

Further, also according to sub audio ES (SA_ES) constituting the compressed voice stream stored to the sub voice buffer 26, as shown by FIG. 2 (b), 1 frame is constituted by stream information, compressed data and extended data constituting a head by Syncword constituting synchronization information.

Further, the stream information region is stored with various information with regard to compressed data, size information of the compressed voice stream of an amount of 1 frame and the like along with main audio ES (MA_ES) and sub audio ES (SA_ES). Further, the compressed data region is stored with a coded voice data constituting an object of actual decoding. Further, normally, the extended data region is outside of an object of the decoding processing and constitutes a region which is read and abandoned in decoding.

Further, as shown by FIG. 2 (c), the noncompressed voice data (EF_PCM) constituting effect audio stored to the effect buffer 28 are continuously consecutive and is subjected to multiplex processing by constituting 1 unit by a data amount in correspondence with a reproduction time period of an amount of 1 frame of main audio ES (MA_ES) and sub audio ES (SA_ES).

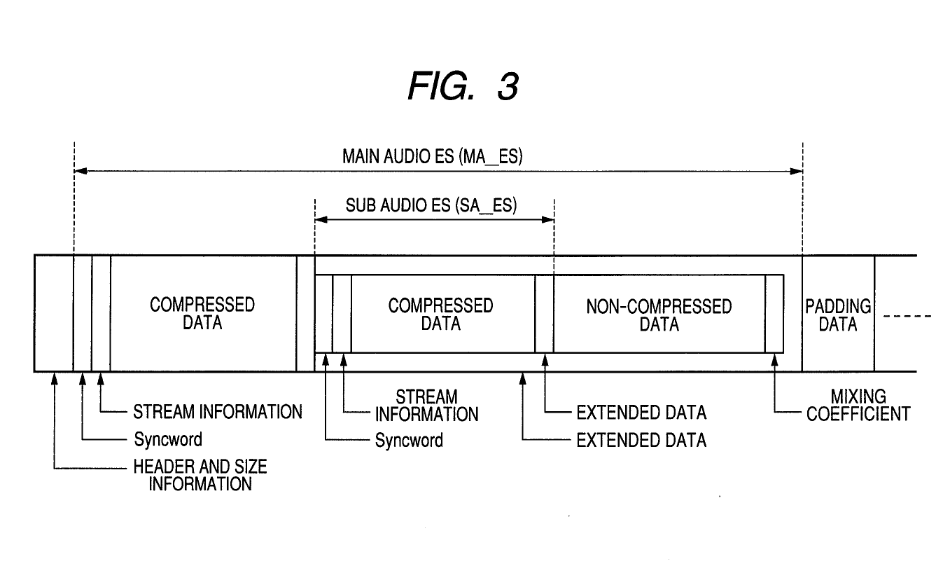

Further, according to the multiplex processing portion 23, as shown by FIG. 3, sub audio ES (SA_ES) constituting 1 frame and the noncompressed voice data (EF_PCM) in correspondence with a reproduction time period of an amount of 1 frame and the mixing coefficient are inserted to an extended data region of main audio ES (MA_ES) constituting 1 frame, and size information disposed at inside of stream information of main audio ES (MA_ES) is rewritten. Further, in a case of a compressed voice stream in which a data used for an error check of, for example, CRC (cyclic redundancy check) or the like is present, it is necessary to rewrite by recalculating the data.

Thereafter, the multiplex processing portion 23 adds predetermined header and size information to a head of main audio ES (MA_ES) constituting 1 frame and adds a padding data to a tail thereof. The multiplex processing portion 23 respectively subjects continuous respective frames of main audio ES (MA_ES) to the above-described multiplex processing to be outputted to the interface portion 30.

According to the above-described embodiment, a single piece of the compressed voice stream is generated by inserting sub audio ES (SA_ES) and the noncompressed voice data (EF_PCM) and the mixing coefficient to the extended data region of main audio ES (MA_ES), that is, the plurality of kinds of compressed voice streams are efficiently multiplexed by utilizing structures thereof, and therefore, by achieving a reduction in a number of transmission lines in being outputted to outside, the embodiment can be made to be sufficiently suitable for practical use.

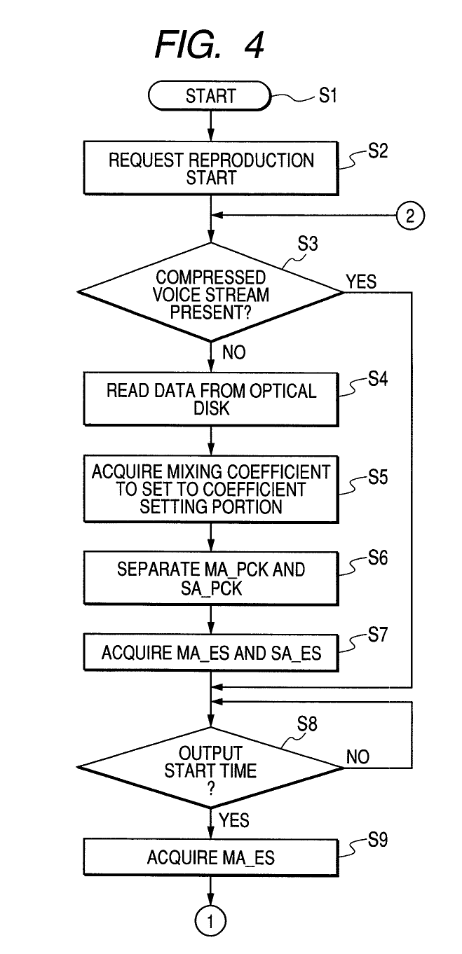

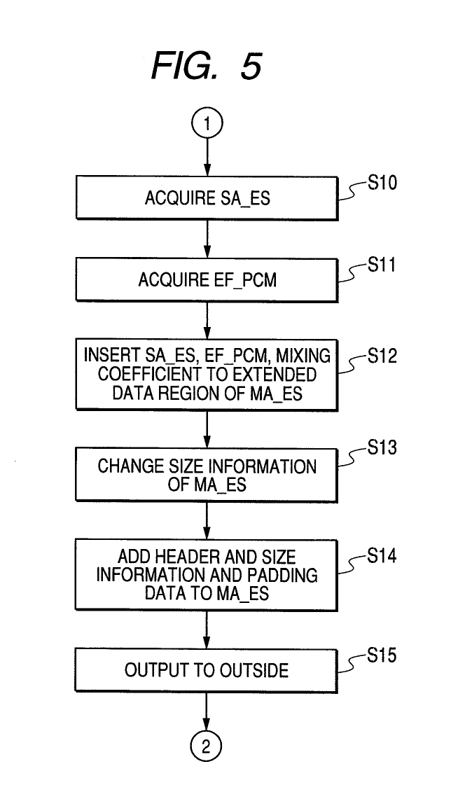

FIG. 4 and FIG. 5 show a flowchart summarizing the multiplex processing operation of the disk reproducing apparatus 11. That is, when the processing is started (step S1) and start of reproduction is requested at step S2, the control portion 33 determines whether the compressed voice stream to be reproduced is present in the main voice buffer 22 and the sub voice buffer 26.

Further, when it is determined that the compressed voice stream is not present (NO), the control portion 33 makes data read from optical disk 12 at step S4 and acquires the mixing coefficient from the read data to be set to the coefficient setting portion 29.

Further, the control portion 33 makes a processing of separating main audio pack (MA_PCK) and sub audio pack (SA_PCK) carry out from the read data at step S6 and makes main audio ES (MA_ES) and sub audio ES (SA_ES) extracted to be acquired by the main voice buffer 22 and the sub voice buffer 26 at step S7.

Thereafter, or when it is determined that the compressed voice stream to be reproduced at step S3 is present in the main voice buffer 22 and the sub voice buffer 26 (YES), the control portion 33 determines whether output start time is reached at step S8, when it is determined that the output start time is reached (YES) the control portion 33 makes main audio ES (MA_ES) of the main voice buffer 22 acquired by the multiplex processing portion 23 at step S9.

Next, the control portion 33 makes sub audio ES (SA_ES) of the sub voice buffer 26 acquired by the multiplex processing portion 23 at step S10, and makes noncompressed voice data (EF_PCM) of the effect buffer 28 acquired by the multiplex processing portion 23 at step S11.

Further, the control portion 33 makes sub audio ES (SA_ES) and the noncompressed voice data (EF_PCM) and the mixing coefficient inserted to the extended data region of main audio ES (MA_ES) at step S12 and makes size information included in the stream information of main audio ES (MA_ES) changed at step S13.

Thereafter, the control portion 33 makes header and size information and padding data added to main audio ES (MA_ES) at step S14, makes main audio ES (MA_ES) outputted to outside from the output terminal 31 by way of the interface portion 30, thereafter, returns to the processing of step S3.

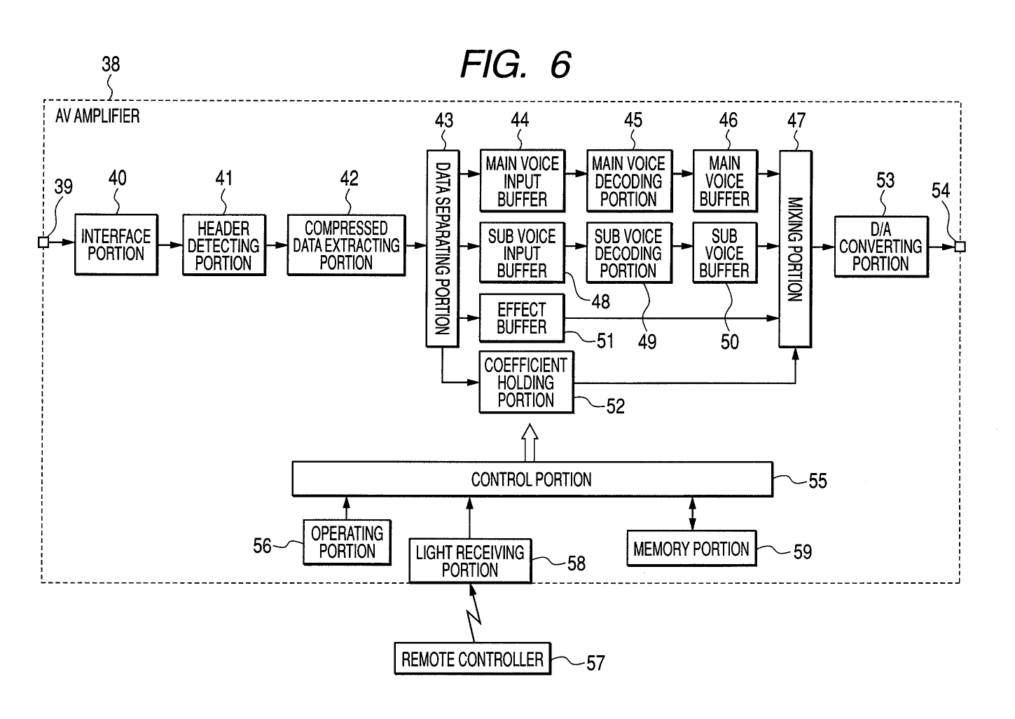

Next, FIG. 6 shows an example of an AV amplifier 38 inputted with a single piece of the compressed voice stream multiplexed with main audio ES (MA_ES), sub audio ES (SA_ES), the noncompressed voice data (EF_PCM) and the mixing coefficient.

That is, the AV amplifier 38 includes a digital voice input terminal 39 inputted with the compressed voice stream outputted by the transmission mode in conformity with HDMI standard from the digital voice output terminal 31 of the disk reproducing apparatus 11.

Further, the compressed voice data inputted to the digital voice input terminal 39 is received by an interface portion 40 in conformity with the HDMI standard, supplied to a header detecting portion 41 to detect header and size information, thereafter, supplied to a compressed data extracting portion 42. The compressed data extracting portion 42 extracts the compressed voice stream of an amount of 1 frame based on the size information detected at the header detecting portion 41 to be outputted to a data separating portion 43.

The data separating portion 43 separates main audio ES (MA_ES), sub audio ES (SA_ES), the noncompressed voice data (EF_PCM) and the mixing coefficient from the inputted compressed voice stream of an amount of 1 frame.

Main audio ES (MA_ES) thereamong is stored to a main voice input buffer 44, thereafter, the compressed data is decoded by a main voice decoding portion 45. Further, audio data outputted from the main voice decoding portion 45 is stored to a main voice buffer 46, thereafter, supplied to a mixing portion 47.

Further, sub audio ES (SA_ES) separated by the data separating portion 43 is stored to a sub voice input buffer 48, thereafter, the compressed data is decoded by a sub voice decoding portion 49. Further, sub audio data outputted from the sub voice decoding portion 49 is stored to a sub voice buffer 50, thereafter, supplied to the mixing portion 47.

Further, the noncompressed voice data (EF_PCM) separated by the data separating portion 43 is stored to an effect buffer 51 and is supplied to the mixing portion 47. Further, the mixing coefficient separated from the data separating portion 43 is stored to a coefficient holding portion 52, thereafter, supplied to the mixing portion 47.

Further, the mixing portion 47 generates a voice data by mixing main audio data stored to the main voice buffer 46, sub audio data stored to the sub voice buffer 50, the noncompressed voice data (EF_PCM) stored to the effect buffer 51 based on the mixing coefficient held by the coefficient holding portion 52. The voice data generated by the mixing portion 47 is supplied to a D/A converting portion 53 to be converted into analog, thereafter, subjected to a voice reproduction by a speaker (not illustrated) at outside by way of a voice output terminal 54.

Here, according to the AV amplifier 38, all of operations including the voice reproducing operation are comprehensively controlled by a control portion 55. The control portion 55 includes CPU or the like, receives operation information from an operating portion 56 or operation information transmitted from a remote controller 57 received by a light receiving portion 58 to respectively control respective portions such that a content of the operations is reflected.

In this case, the control portion 55 utilizes a memory portion 59. The memory portion 59 mainly includes ROM stored with a control program for being executed by CPU of the control portion 43, RAM for providing an operation area to the CPU, and an involatile memory for storing various setting information and control information or the like.

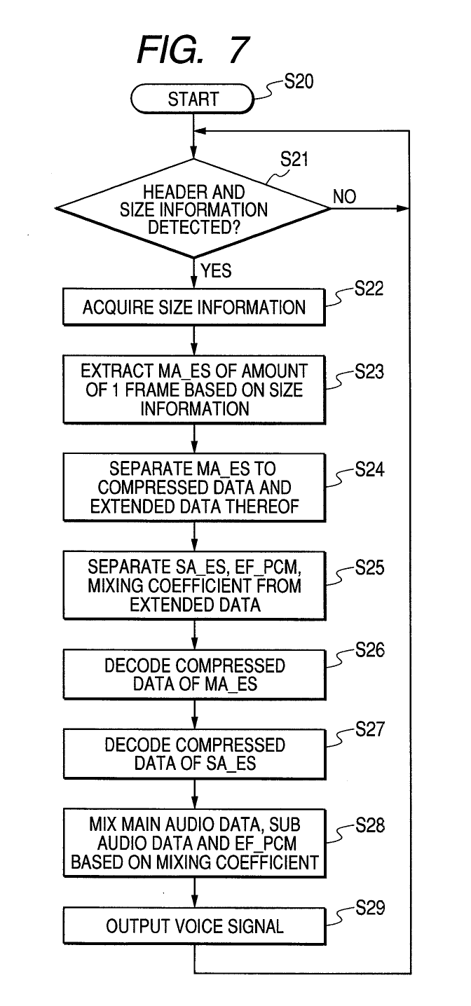

FIG. 7 shows a flowchart summarizing a voice reproduction processing operation of the AV amplifier 38. The voice reproduction processing is started (step S20) by supplying the compressed voice stream to the digital voice input terminal 39 of the AV amplifier 38. Then, the control portion 55 determines whether header and size information are detected by the header detecting portion 41 at step S21, when it is determined that the header and size information are detected (YES), the control portion 55 acquires size information from the detected header and size information at step S22.

Thereafter, the control portion 55 extracts main audio ES (MA_ES) of an amount of 1 frame based on the size information by the compressed data extracting portion 42 at step S23 and separates extracted main audio ES (MA_ES) to compressed data and extended data thereof by the data separating portion 43 at step S24.

Further, the control portion 55 respectively separates sub audio ES (SA_ES), the noncompressed voice data (EF_PCM) and the mixing coefficient from the extended data by the data separating portion 43 at step S25.

Further, the control portion 55 decodes the compressed data of main audio ES (MA_ES) by the main voice decoding portion 45 at step S26 and decodes the compressed data of sub audio ES (SA_ES) by the sub voice decoding portion 49 at step S27.

Thereafter, the control portion 55 mixes main audio data and sub audio data and the noncompressed voice data (EF_PCM) based on the mixing coefficient by the mixing portion 47 at step S28, converts the mixed voice data into analog to be outputted at step S29, thereafter, is returned to the processing of step S21.

As described with reference to the embodiment, one piece of the compressed voice stream is generated by inserting the second compressed voice stream to the extended data region of the first compressed voice stream, that is, a plurality of kinds of the compressed voice streams are efficiently multiplexed by utilizing structures thereof, and therefore, the invention can be made to be sufficiently suitable for a practical use by achieving a reduction in a number of transmission lines in being outputted to outside.

Further, the invention is not limited to the above-described embodiment as it is but can be embodied by variously modifying constituent elements within the range not deviated from the gist at an embodying stage. Further, various inventions can also be formed by pertinently combining a plurality of constituent elements disclosed in the embodiment. For example, a number of constituent elements may be deleted from all of constituent elements shown in the embodiment. Further, constituent elements according to different embodiments may pertinently be combined.

What is claimed is:

1. An audio outputting apparatus comprising:
a first input unit into which a first compressed audio stream is configured to be input with respect to a series of data frames, the first compressed audio stream including compressed audio data and extended data;
a second input unit into which a second compressed audio stream is configured to be input with respect to a series of data frames, the second compressed audio stream including compressed audio data;
a multiplex unit configured to insert the second compressed audio stream into an extended data region of a corresponding frame of the first compressed audio stream to generate a multiplexed compressed audio stream; and
an output unit that externally outputs the multiplexed compressed audio stream in a predetermined transmission mode.

2. The audio outputting apparatus according to claim 1, wherein the multiplex unit is configured to insert one frame of the second compressed audio stream to the extended data region of one frame of the first compressed audio stream.

3. The audio outputting apparatus according to claim 1, wherein the multiplex unit is configured to add header information and size information to a head of each frame of the first compressed audio stream with the second compressed audio stream inserted at the extended data region.

4. The audio outputting apparatus according to claim 1, wherein the multiplex unit is configured to insert a mixing coefficient to an extended data region of the first compressed audio stream along with the second compressed audio stream, the mixing coefficient for mixing a first audio signal and a second audio signal, the first audio signal obtained by decoding the compressed audio data included in the first compressed audio stream, the second audio signal obtained by decoding the compressed audio data included in the second compressed audio stream.

5. The audio outputting apparatus according to claim 1, wherein the multiplex unit is configured to insert non-compressed audio data into an extended data region of the first compressed audio stream along with the second compressed audio stream.

6. The audio outputting apparatus according to claim 5, wherein the non-compressed audio data corresponds to the first and the second compressed audio streams with respect to the reproducing time for each frame.

7. The audio outputting apparatus according to claim 5, wherein the multiplex unit is configured to insert a mixing coefficient into the extended data region of the first compressed audio stream along with the second compressed audio stream and the non-compressed audio data, the mixing coefficient for mixing a first audio signal, a second audio signal, and a third audio signal, the first audio signal obtained by decoding the compressed audio data included in the first compressed audio stream, the second audio signal obtained by decoding the compressed audio data included in the second compressed audio stream, the third audio signal obtained by decoding the non-compressed audio data.

8. An audio outputting method comprising:
inputting a first compressed audio frame including compressed audio data and extended data;
inputting a second compressed audio frame including compressed audio data;
inserting the second compressed audio frame into an extended data region of the first compressed audio frame to generate a multiplexed compressed audio stream; and
externally outputting the multiplexed compressed audio stream in a predetermined transmission mode.

9. An audio receiving apparatus comprising:
a receiving unit configured to receive a multiplexed compressed audio stream, the multiplexed compressed audio stream including a first compressed audio stream and a second compressed audio stream in an extended data region of the first compressed audio stream;
a separating unit configured to separate compressed audio data included in the first compressed audio stream and compressed audio data included in the second compressed audio stream from the multiplexed compressed audio stream; and
a decoding unit configured to decode the respective compressed audio data separated by the separating unit.
